(19) United States
(12) Patent Application Publication
(10) Pub. No.: US 2012/0198959 A1
(43) Pub. Date: Aug. 9, 2012

(54) TRAVEL SIMULATOR ARRANGEMENT

(75) Inventors: Heinz Leiber, Oberriexingen (DE); Christian Koglsperger, Geretsried (DE); Carsten Hecker, Munich (DE); Rainer Winzer, Munich (DE)

(73) Assignee: IPGATE AG, Pfaffikon Sz (CH)

(21) Appl. No.: 13/346,527

(22) Filed: Jan. 9, 2012

(30) Foreign Application Priority Data
Jan. 11, 2011 (DE) DE 10 2011 008 32

(51) Int. Cl. B60T 7/04; G05G 1/30

(52) U.S. Cl. 74/514

(57) ABSTRACT

The invention relates to a travel simulator arrangement, in particular for motor vehicle braking systems, having a travel simulator which has a means, in particular a resilient or elastic one, to represent an actuating travel as a function of an actuating force, characterised in that the travel simulator (8) has assigned to it an adaptive means which produces a variable opposing force to the travel simulator force.

The invention relates to a travel simulator arrangement, in particular for vehicle braking systems.

### PRIOR ART

In new developments in new braking systems, a clear trend is apparent towards integration, i.e. towards all components being combined into a single unit structure, and towards the use of pedal travel simulators, which have various advantages. Disadvantages of what are referred to as brake boosters using a pedal travel simulator are a synthetic feel to the pedal at high pedal speeds. In conventional servo boosters, for example as vacuum-operated brake boosters, the force on the pedal is boosted by a booster member. There is always a direct feedback of force in this case at the time of any pedal movement. In the case of travel simulators it is the travel simulator spring which acts and in the case of hydraulic travel simulators it is a fixed throttle.

The stop to which the travel simulator spring is subject, which is situated at approximately 40% of the total pedal travel, is switched off if the brake booster fails, thus enabling the whole of the pedal travel to be used to generate braking pressure. As a rule, this stop is not a nuisance because it is only reached when braking as hard as possible. The driver is then concentrating entirely on the braking. When the vehicle is stationary however this stop is very much a nuisance because in this case there is not usually anything to divert the driver's attention.

In the event of a fault, e.g. in the event of the failure of control valves in the travel simulator, there is no feedback from the travel simulator to the brake pedal, which means either that the brake booster is operated without any opposing force acting, which may possibly result in braking being unintentionally as hard as possible, or that the brake booster is switched off by the fault diagnostics. Both of these are irritating to the driver and may result in accidents.

To remedy disadvantages of known solutions, there are known travel simulators which have a fixed throttle or flow control device, but these in turn have the disadvantage that the pedal speed, and hence the speed of displacement of the main-cylinder piston too, is damped when the boost is applied as a function of pedal travel.

### OBJECT OF THE INVENTION

The object underlying the invention is to provide a travel simulator which remedies the disadvantages of known travel simulators and in particular improves the feel of the pedal, there being little adverse effect on the speed of displacement of the main-cylinder piston, in particular when the pedal is moved fast.

### ACHIEVING THE OBJECT

One way of achieving this object is, in accordance with the invention, by assigning to the travel simulator an adaptive means which produces a variable opposing force to the travel simulator force.

Another way of achieving the object in accordance with the invention is to make the action of the travel simulator able to be reduced and/or, in particular when the vehicle is stationary, able to be switched off. A changeover to servo boosting may take place in this case, with the force on the pedal acting on the boosting action of the brake booster and thus on the main-cylinder piston. A remedy can thus be provided for the effect which is a nuisance when stationary, which arises from the travel simulator coming up against the stop, and/or for the effects which irritate the driver in the event of faults, when for example there is no feedback from the travel simulator to the brake pedal, which means either that the brake booster is operated without any opposing force acting, which may possibly result in braking unintentionally being as hard as possible, or that the brake booster is switched off. A changeover can be made in this case to servo boosters on the fault being detected. Because the travel simulator is no longer acting, the pedal travels are longer but boosting is maintained. An indication of a fault on the vehicle display makes it clear to the driver that he has to take the vehicle in for servicing.

Considered in the widest sense, the action of the travel simulator is acted on or switched off as a function of the state of operation and possible faults.

The variable opposing force from the travel simulator, and hence the effect of a variable damping force, can be controlled as a function of various vehicle parameters for example pedal speed, pedal position, vehicle speed or temperature.

The solution according to the invention provides a travel simulator which, with an improved feel to the pedal, gives the substantial advantages of travel simulators, namely shorter pedal travels and a faster build-up of pressure, a variable, adaptive jump in pressure at the beginning of braking (which can be optimised for different ranges), a better fallback level if the brake booster fails (familiar pedal characteristic and lower pedal forces), no change to the pedal characteristic if fading occurs, ideal characteristics for hybrid vehicles with recuperative braking, pedal does not go to the floor if the braking circuit fails, automatic diagnosis of the bled state, and a travel simulator in the case of which there is no adverse effect on the pedal speed.

The invention also provides in particular a throttling effect which is independent of temperature as far as possible, of the path simulator device. This can be configured in the form of a choke as an orifice plate with a flow resistance which is independent of temperature as far as possible. For this purpose, an element can be provided which has a differing linear expansion and which, at low temperatures, forms an annular gap as a bypass. A magnetic valve connected upstream of the path simulator can optionally be operated by pulse-width modulation (PWM).

Advantageous embodiments or configurations of the invention can be seen from the dependent claims.

Exemplary embodiments of the invention and configurations thereof are shown in the drawings and are described in detail below.

In the drawings:

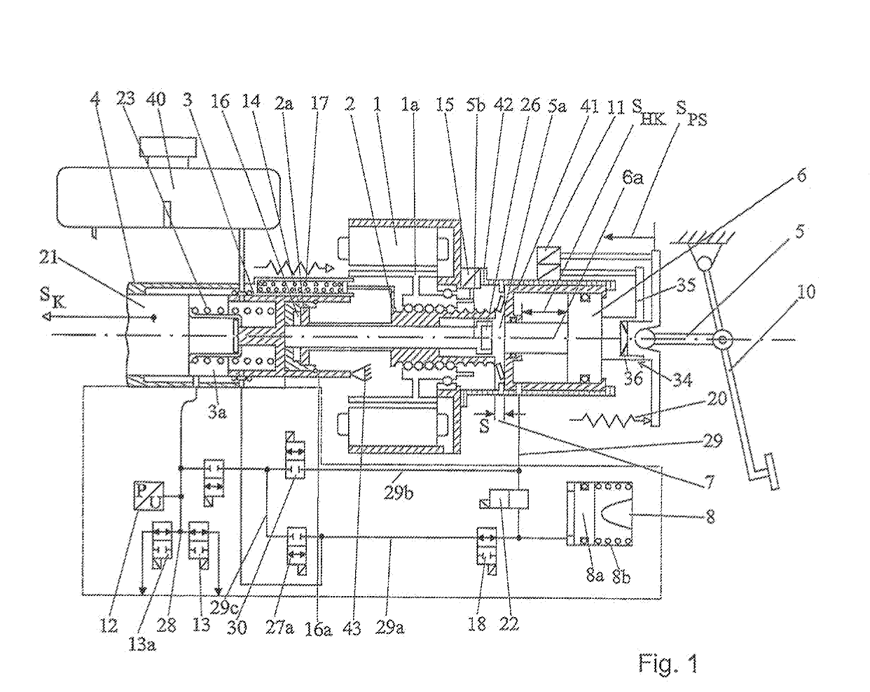

FIG. 1 shows a travel simulator arrangement which is used in a brake actuating system for a motor vehicle which has a brake booster having a hydraulic travel simulator.

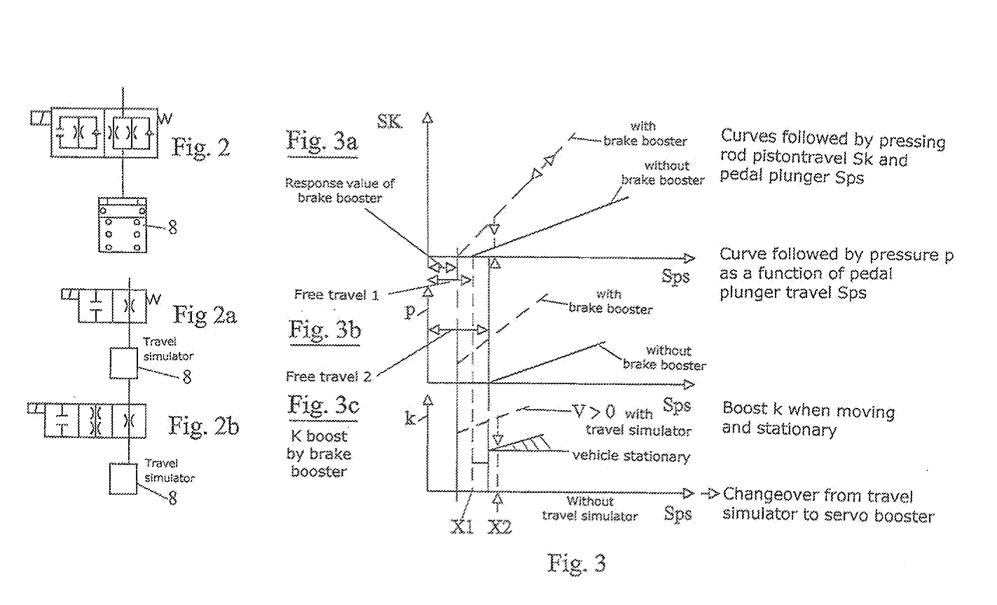

FIGS. 2, 2a and 2b show various design of valve.

FIGS. 3a to 3c show the changeover of the system to servo boosting in the stationary state.

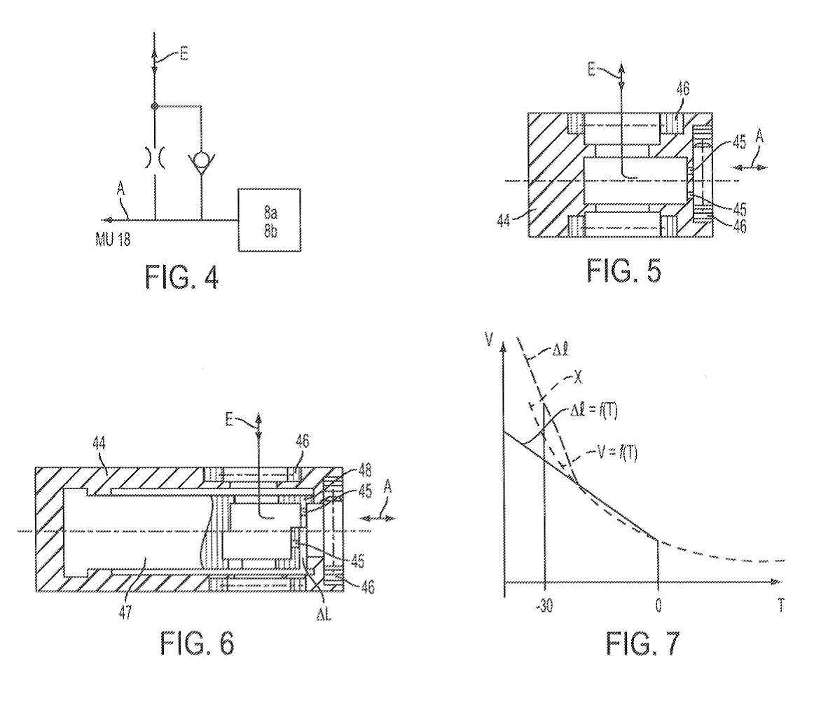

FIG. 4 is a schematic diagram of a choke with a return valve;

FIG. 5 shows a throttling element with an orifice plate;

FIG. 6 shows a throttling element with an orifice plate and a temperature-dependent annular gap; and

FIG. 7 is a diagram.

The embodiment of actuating system for a vehicle brake which is shown in FIG. 1 has a first piston-and-cylinder unit 4 in whose body a first piston (pressing-rod piston) 3 and a second piston (floating piston) 21 are arranged to be axially displaceable. By means of springs, the pistons 3, 21 are supported against the end-wall of the cylinder (not shown) and against one another 23. The first piston 3 takes the form of a hollow piston. The piston-and-cylinder unit 4 is connected to a boosting arrangement which has a rotary drive in electric motor which acts in both directions, which is controlled by an electronic control unit (ECU) (not shown) and which has a stator 1 and rotor 1a and a transmission mechanism for converting a rotary movement into a linear movement and for gearing the ratio of drive. The rotor 1a is mounted in the housing of the drive by means of two bearings. The transmission mechanism is provided with a recirculating-ball spindle 2 which is arranged concentrically in the rotor 1a to be movable axially but fixed in rotation. The recirculating-ball spindle 2 is supported by its front end 2a, which is of a flange-like form, on an intermediate wall of the piston 3 and is coupled to the piston by positive interengagement or by a force, and advantageously by means of a magnetic coupling 16, which means that movements of the spindle 2 in both directions are thus transmitted to the piston 3. The other end of the spindle 2 is supported on the housing by means of a disc spring or the like. A return arrangement 17 for the spindle has a slider on which a spring 17 which is arranged on or in the body of the piston-and-cylinder unit operates. A plunger 5b which is co-axially mounted within the spindle 2 to be displaceable is fastened to the piston 3 by its front end and has a magnetic coupling 26 at its rear end. The magnetic coupling co-operates with a central projection from an auxiliary piston 6 (in the way which will be described below). The movements of the rotor can be measured by means of an angle-of-rotation sensor 15 and the corresponding signals can be fed to an electronic control unit (ECU) (not shown).

The auxiliary piston 6 is part of a second piston-and-cylinder unit which is mounted in front of, in particular co-axially with, the transmission mechanism. The second piston-and-cylinder unit has a cylinder 41, arranged in a housing 42, in which the auxiliary piston 6 is arranged by a central projection 6a. The projection 6a passes through a central opening in the housing 42 and co-operates with the magnetic coupling 26 by means of a flange portion 5a. A short spacing or amount of free travel (s) 7 is provided between the flange portion 5a and the rear end of the plunger or the magnetic coupling.

The system has for this purpose two, or at least one, coupling. The first non-positively held coupling 14 preferably has a permanent magnet 16 embedded in a magnet housing 16a and acts on a pole-piece 2a of the spindle. This coupling is required on the one hand to boost the return of the piston by the spindle with the force exerted at the coupling, in particular at low pressures.

The second coupling acts on the front end of the transmitting plunger 5b, which is firmly connected to the pressing rod piston 3 by means of the magnet housing. This second non-positively held coupling too is preferably constructed to have a permanent magnet having a pole 5a on the auxiliary piston. The small amount of free travel (s) 7 provided between the pole 5a and the transmitting plunger 5b is used amongst other thing to give the pedal its characteristic and to calibrate the pedal travel sensors.

Between the plunger 5 connected to the brake pedal and the auxiliary piston 6 is provided a transmission arrangement 34 which has a transmission member 35 which has a cylindrical projection which is arranged to be axially displaceable in a corresponding cylindrical recess in the auxiliary piston, or in a projection from the auxiliary piston, and on which transmission member 35 a spring 20 acts to return the auxiliary piston 6. The auxiliary piston 6, together with its seals, is guided and mounted in an appropriate housing 41. This housing 41 may be connected to the motor 1 by means of a multi-piece intermediate housing 42 which is preferably made of plastics material. The housing 41 and intermediate housing may also be all in one piece.

Arranged between the cylindrical projection and the recess is a resilient member or spring 36. The auxiliary piston 6 and transmission member 35 each have transmitting means by which their movement is transmitted to at least two travel sensors 11. The signals from the travel sensors are fed to the above-mentioned ECU. By means of the resilient member and a measurement of differential travel, the force on the pedal can be measured and this corresponds to a force vs. travel sensor, which is very important for fault diagnosis.

A hydraulic line 29 runs to the travel simulator 8, which substantially comprises a piston 8a arranged in a cylinder and a spring 8b arranged between them. Arranged in the line is a 2-way solenoid valve 22 which is used to isolate the travel simulator 8 and for adaptive damping or flow restriction (see FIGS. 2 to 2b). Branching off from the line 29 is a line 29a which runs to the supply reservoir 40 via a 2/2-way solenoid valve 18 which is open in the de-energised state. A further line 29b runs, via a 2/2-way solenoid valve 30 which is closed in the de-energised state, from the line 29 to the pressure chamber 3a, associated with the piston 3, of the first piston-and-cylinder unit (THZ) 4. A line 29c connects the lines 29a and 29b via a 2/2-way solenoid valve 27a which is closed in the de-energised state. Running from the pressure chamber 3a to the wheel brakes (not shown) via solenoid valves 13, 13a which are open in the de-energised state is a line 28 in which a pressure sensor 12 is arranged. Corresponding lines (not shown) run from the second pressure chamber of the piston-and cylinder unit to the other wheel brakes.

The brake pedal 10 acts via the pedal plunger 5 on the auxiliary piston 6, the volume which is displaced by this latter making its way via the line 29 to the hydraulic travel simulator 8. Coupled to the movement of the auxiliary piston 6 are redundant travel sensors 11 which, via the ECU, operate the motor and at the same time actuate, i.e. close, the 2/2-way pressure-regulating solenoid valve 18 which is open in the de-energised state.

The desired feedback to the force at the pedal is produced by the travel simulator 8. The auxiliary piston 6 is blocked in an intermediate position at approximately 40% of the total piston travel S_{HK} if the travel simulator piston 8a comes into abutment. As dictated by the spring 8b of the travel simulator, a pressure dependent on pedal travel comes into being at the auxiliary piston 6. The solenoid valve has a pressure regulating function for safety reasons. Should the travel simulator piston 8a jam, the pedal travel vs. pressure function is disrupted, i.e. via the solenoid valve pressurised medium flows via the line 29a to the supply reservoir 40. If an appropriate pressure is exceeded, pressurised medium flows away and the auxiliary piston 6 moves up against a stop in the housing 41 after traversing the travel S_{HK}. As a function of the position of the pressing rod piston 3 and the coupled transmitting plunger 5b, the auxiliary piston 6 impacts on these and generates an additional pressure in the piston-and-cylinder unit 4, which additional pressure however, as a result of its sizing, corresponds to the maximum braking pressure required but not to an over-pressure caused by the high pedal forces. Weight and expense can thus be saved for the sizing. If such over-stressing occurs, the motor, and hence the ABS/ESP functions too, are switched off. The higher pressure acts only on the auxiliary piston 6 and the travel simulator 8.

The force vs. travel sensor may also be used as an alternative to or in parallel with the pressure regulating function. If for example the pressure regulating valve 18 fails, the force vs. travel sensor finds that there is no opposing force from the travel simulator at a given pedal travel. The piston and the pedal-plunger travel are thereupon made equal and the boosting is determined by means of the force vs. travel sensor. When this is the case, the brake booster is operated as a servo booster without a travel simulator.

To give a good response characteristic, it is known for a means of controlling the flow for actuation, with the flow control dependent on speed and direction, to be installed. For this purpose, a flow-control like a throttle is fitted in the line to the travel simulator and a non-return valve (not shown) is fitted for a fast return. However, as described in the opening paragraphs, this known solution has disadvantages, which are remedied by the solution according to the invention.

If the brake booster fails, the auxiliary piston 6 can continue to be used to optimise the braking action. If the brake booster fails, the force on the pedal needs to be as small as possible, which calls for small diameters for the main-cylinder piston. If these are used, then long pedal travels will be needed in the low pressure range due to the shallow slope of the pressure vs. volume characteristic.

Via a 2/2-way solenoid valve or infeed valve 30 (S_{E}) which is closed in the de-energised state, pressurised medium can be fed in the lower pressure range into the pressing rod piston circuit 28 by the auxiliary piston 6 to build up pressure. When the pressure declines, pressurised medium can be fed back to the auxiliary piston by means of the pressure sensor 12.

The 2/2-way solenoid valve which is closed in the de-energised state is used for controlling free travel, i.e. if the distance from the auxiliary piston 6 to the transmitting plunger 5b becomes too small, hydraulic fluid can be drained into the supply reservoir 40 via the valve, in the way which is described in detail in the same applicant's DE 10 2009 055721. If the free travel is too large, a volume of medium can be drawn in from the supply reservoir by appropriate control of the piston. The valve can also be used for the same function in the other brake circuit(s). By means of this valve, a volume of medium can also be drawn in from the supply reservoir via the main-cylinder piston.

Shown in FIGS. 2, 2a and 2b are various switching members taking the form of solenoid valves for variable or adaptive throttles which can be connected upstream of the travel simulator 8.

FIG. 2 shows a two-position solenoid valve having different flow resistances for flow control. In the starting position, two throttles act, one having a smaller throttle effect and one having a large throttle effect. If required, a non-return valve is incorporated in the valve to keep the flow-controlling/throttle action small when the brake pedal is relaxed. In the switched state, i.e. at high pedal speeds, it is only the large throttle applying high damping which acts. At high pedal speeds, the large throttle is preferably switched on as a function of pedal travel. At extreme pedal speeds, such as in panic braking for example, the large throttle can be reduced, i.e. the flow control of the throttle can be varied or even switched off completely during the movement of the pedal.

The solenoid valve may be switched by pulse width modulation (PWM) to give mean values.

FIG. 2a corresponds to a solution which is based entirely on PWM. In this case, a flow control or throttle which is continuously variable within wide limits may be constituted by control of the pulse-to-pause ratio. For this purpose, it is advantageous for reasons connected with noise for the solenoid valve to be provided with a damping arrangement or with damping members in the case of the valve seat and the armature stop. The valve seat preferably takes the form of a slider in this case and the armature rests against an elastomeric part.

FIG. 2b shows a 3-stage valve in which throttle resistances are connected one behind the other in the second throttle stage 2. In the third stage, as in the second stage shown in FIG. 2a, the connection to the travel simulator is blocked to allow the whole of the volume of medium from the auxiliary piston to be conveyed to the braking circuit in the emergency situation described.

The versions shown in FIGS. 2a and 2b are suitable in a particularly advantageous way for enabling the travel simulator and the volume of medium it absorbs to be switched off in emergency operation. In this case the entire volume of medium from the auxiliary piston can be fed to one or both braking circuits via the infeed valve 30.

With the valve variants or circuits shown, almost any desired throttle or flow-controlling resistances can be constituted. An adaptive opposing force is thus generated by the throttle, and the spring effect of the travel simulator is thus hardly noticed any longer. For this purpose, the pedal speed or the pedal position or other parameters are usefully converted adaptively into the throttling by means of appropriate control algorithms. The opposing force generated by the variable damping or flow restrictor can, though at considerably greater cost and complication, be produced by an actuator, e.g. a motor.

It is conceivable that faults may switch off the travel simulator, e.g. a failure of the solenoid valve 18, i.e. failure thereof to close, as described above. In this case, there is no opposing force and the driver will necessarily press the brake pedal harder, which will result in a sharp rise in pressure and corresponding deceleration. This is detected as a result of the indirect measurement of force via the resilient member 34, 36 not giving a force proportional to pedal travel. In this case the pedal travel is compared with the piston position and the boost is set in accordance with the force measured if the auxiliary piston impacts on the transmitting plunger. There are other possible faults such as jamming of the travel simulator piston or the valve 22 closed or the variant shown in 2a. In this case, on the fault being detected, a changeover is made to the servo booster by means of the force vs. travel sensor, which is done by the force on the pedal acting via the connecting means described on the main-cylinder piston.

Alternatively, use may also be made of a control system such as is shown in FIGS. 3a to 3c and such as will be described below. FIG. 3a shows the relationship between the travel S_{K} of the pressing rod piston and the pedal-plunger travel, with and without the brake booster. The movement of the pressing rod piston 3 takes place very quickly following passage through the response value of the brake booster, which value is substantially dependent on the pedal travel sensor. With the brake booster, the pressing rod piston has a lead on the pedal plunger. If the brake booster fails, a free travel 1 is traversed before the pedal plunger impacts on the pressing rod piston 3 and moves it. FIG. 3b shows the curves for pressure with and without a brake booster. After the response value of the brake booster, the build-up of pressure takes place in a type of jump (by a so-called jumper function) and then follows a path as dictated by the design of the travel simulator. Without a brake booster, a free travel is required until the pressing rod piston closes the snifter hole and the pressure then rises. At the top, FIG. 3c shows the brake booster boosting as a function of the pedal plunger travel when there is a travel simulator, i.e. in normal operation and when v>0. When the vehicle is stationary, a changeover can then be made at X from travel simulator operation to conventional servo booster operation. This is where the pedal plunger impacts on the pressing rod piston. After travel through the free travel 1, the boost comes into effect, so that the return forces on the piston and spindle are less able to be felt and continue to increase after the free travel 2 as the pressure builds up. The boost may be so selected in this case that there is the same feel to the pedal as with the travel simulator without stop. What have been described here are the processes which happen when the vehicle stands when being braked.

It is shown at X₂ in FIGS. 3a and 3c what happens when the vehicle is braked from v>0. In this case the floating piston is controlled to the value from the pedal plunger in the region between free travels 1 and 2. If a given pressure, e.g. braking at 10 bars, is maintained at a standstill, then the pressing rod travel S_{K} is similarly made equal to the S_{PS} value at this value.

The problem mentioned of the pedal speed being damped to a commensurate extent when damping is heavier can be solved by suitable algorithms for an increased speed of pedal actuation. If, as in the prior art in the case of EHB (electro-mechanical brake-by-wire), the flow controlling action relative to the travel simulator were small, then the boost could be designed to be almost proportional to the pedal position with a suitable amplification factor in line with the travel simulator characteristic. If the damping were heavier, the pedal position and pedal speed and hence the piston speed or the rise in pressure over time would be slowed down. However, since the reduced pedal speed with damping is known, an initially higher piston speed can be set in this case, once again adaptively, by means of appropriate algorithms. Because of the correspondingly high speed of the rise in pressure, the driver will reduce the pedal speed due to the sharp rise in pressure, and he will thus settle almost to the original correlation between pedal travel and pressure. As an alternative to this, there may be used in the travel simulator circuit too a pressure sensor (not shown) whose signal is likewise, via the algorithms, used to control the piston travel or the piston speed.

The schematic diagram, shown in the figure, of a choke with a return valve is derived from FIG. 2. As an alternative to the choke shown in FIG. 2, the throttling effect can also be realised by a temperature-dependent throttling element which is connected in particular at inlet E to the auxiliary piston 6 and at outlet A to the magnetic valve 18.

FIG. 5 shows a throttling element 44 with orifice plates 45 which are protected against soiling by filters at the inlet and outlet. The diameters of the orifice plates are relatively small and are thus susceptible to soiling. For this reason, the filters are configured appropriately with respect to their mesh width and in particular are 3-5 times smaller than the diameters of the orifice plates. The throttling effect is preferably distributed over more than two orifice plates.

FIG. 6 shows a combination of an orifice plate with a temperature-equalising element 47. This element 47 has a much greater thermal expansion than the throttling element or the choke housing 44 and acts as a valve element. At a specific temperature of, for example 0 degrees Celsius, the temperature-equalising element 47 is positioned on the valve seat 48 and closes the gate of the valve, so that the pressurising medium can only flow through the orifice plate openings. With lower temperatures, a gap ΔI is formed and allows a bypass flow parallel to the orifice plate.

Although the orifice plate is theoretically independent of temperature as far as possible, the supply lines from the auxiliary piston 6 and to the path simulator 8a, 8b or the flow resistors thereof including a proportion of the orifice plate itself are dependent on temperature. The temperature can be equalised through the annular gap. At higher temperatures, the annular gap remains closed. The corresponding linear expansion is accommodated in the equalising element and the throttling element or choke housing. The throttling element is preferably installed in the hydraulic block together with the magnetic valves and pressure transducer.

The diagram of FIG. 7 shows the viscosity curve V=f(T) and the linear expansion of the equalising element which acts, for example below 0 degrees Celsius, since thereafter the viscosity constant increases significantly. It can also be expedient to configure the equalising element in two or more stages corresponding to the course x.

### LIST OF REFERENCE NUMERALS

1 Electric motor or stator
1a Rotor plus nut on spindle
2 Spindle
2a Pole piece of spindle
3 Pressing rod piston
3a Pressure chamber
4 First piston-and-cylinder unit or THZ
5 Pedal plunger
5a Pole on auxiliary piston
5b Transmitting piston
6 Auxiliary piston
7 Free travel (s) at the pedal plunger
8 Travel simulator or travel simulator housing
8a Travel simulator piston
8b Travel simulator spring
10 Brake pedal or actuating means
11 Pedal travel sensor
12 Pressure sensor
13 Control valve
13a Control valve
14 First coupling
15 Angle-of-rotation sensor
16 Permanent magnet
16a Magnet housing
17 Spindle return spring
18 2/2-way solenoid valve or pressure-regulating solenoid valve S_{D}
20 Return spring for auxiliary piston
21 Floating piston
22 Isolating valve for travel simulator
23 Return spring for pressing rod piston
26 Second coupling
28 Pressing rod piston brake circuit
29 Line to travel simulator
29a Line to supply reservoir
30 Infeed valve or 2/2-way valve
34 Transmission arrangement
36 Resilient member
40 Supply reservoir
41 Housing for auxiliary piston
42 Housing intermediate portion
43 Pressing rod piston stop
44 Throttling element
45 Orifice plate
46 Filter
47 Expansion element
48 Valve seat

1. A travel simulator arrangement for motor vehicle braking systems, having:
a travel simulator including a resilient or elastic means to represent an actuating travel as a function of an actuating force, and an adaptive means assigned to the travel simulator and configured to produce a variable opposing force to the travel simulator force.

2. Travel simulator arrangement according to claim 1, wherein the travel simulator is configured so that the action of the travel simulator can be reduced and/or can be switched off.

3. Travel simulator arrangement according to claim 1, wherein at least one of the means incorporates at least one electrically actuatable switching element or a solenoid valve.

4. Travel simulator arrangement according to claim 1, wherein at least one of the means has a throttle, choke or flow controller.

5. Travel simulator arrangement according to claim 1, wherein at least one of the means is configured to act as a function of various parameters including the speed and/or position of an input member, the speed of a vehicle, or the temperature.

6. Travel simulator arrangement according to claim 1, wherein at least one of the means is two-stage or multi-stage.

7. Travel simulator arrangement according to claim 1, wherein at least one of the means is freely or continuously adjustable.

8. Travel simulator arrangement according to claim 7, characterised in that the free or continuous adjustment is achieved by means of pulse width modulation (PWM).

9. Travel simulator arrangement according to claim 4, wherein slowing down of pedal movement at a time of actuation, caused by the throttle, choke or flow control, is wholly or partly compensated for by appropriate countermeasures controlled by algorithms.

10. Method of operating the travel simulator arrangement according to claim 1, wherein, in certain states of operation or cases of faults, an adaptive opposing force to the travel simulator force is brought into action.

11. Method of operating the travel simulator arrangement according to claim 10, wherein the action of the travel simulator can be reduced and/or switched off.

12. Method of operating a travel simulator arrangement according to claim 10, wherein the method further comprises applying a variable opposing force is applied by means of a main-cylinder piston using variable boosting if one or more faults occur.

13. Method according to claim 12, wherein the starting values of a force vs. travel sensor or auxiliary algorithms from pedal and piston positions are used to control the opposing force.

14. Travel simulator device according to claim 1, wherein the adaptive means comprises a means for temperature compensation.

15. Travel simulator device according to claim 14, wherein the means for temperature compensation comprises an orifice plate with a flow resistance which is independent of temperature as far as possible.

16. Travel simulator device according to claim 14, wherein the adaptive means comprises an orifice plate with at least two orifice plate openings which are provided with filters.

17. Travel simulator device according to claim 14, wherein the adaptive means comprises a temperature-dependent equalising element for controlling the flow resistance.

18. Travel simulator device according to claim 14, wherein a magnetic valve connected upstream of the travel simulator is operated by pulse-width modulation (PWM).
